(19) United States
(12) Patent Application Publication
(10) Pub. No.: US 2014/0029246 A1
(43) Pub. Date: Jan. 30, 2014

(54) LIGHTING DEVICE

(71) Applicant: Funai Electric Co., Ltd., Osaka (JP)

(72) Inventor: Shuji UMEDA, Osaka (JP)

(73) Assignee: FUNAI ELECTRIC CO., LTD.

(21) Appl. No.: 13/943,899

(22) Filed: Jul. 17, 2013

(30) Foreign Application Priority Data
Jul. 30, 2012 (JP) 2012-168870

(51) Int. Cl. F21V 7/22

(52) U.S. Cl. CPC F21V 7/22
USPC 362/217.05; 362/296.01

(57) ABSTRACT

A lighting device includes a light emitting element, a board, a cover, and a diffuse reflector. The light emitting element is disposed on the board. The cover houses the light emitting element and the board. The diffuse reflector is disposed on the cover opposite a light emission face of the light emitting element. The diffuse reflector is configured to diffuse and reflect light from the light emitting element. The diffuse reflector has a thickness at a portion opposite the light emission face of the light emitting element that is greater than a thickness at a portion away from the portion opposite the light emission face of the light emitting element.

### CROSS-REFERENCE TO RELATED APPLICATIONS

This application claims priority to Japanese Patent Application No. 2012-168870 filed on Jul. 30, 2012. The entire disclosure of Japanese Patent Application No. 2012-168870 is hereby incorporated herein by reference.

### BACKGROUND

1. Field of the Invention

The present invention generally relates to a lighting device. More specifically, the present invention relates to a lighting device with a cover and a diffuse reflector.

2. Background Information

There are known lighting devices that includes a cover and a diffuse reflector (see Japanese Unexamined Patent Application Publication (Translation of PCT International Application) No. 2012-504307 (Patent Literature 1), for example).

The above-mentioned Patent Literature 1 discloses a fluorescent lamp type of light emitting device that includes a circuit board and a semicircular tubular cover. A light emitting diode is placed on the circuit board. The semicircular tubular cover is disposed on a light emission face side of the light emitting diode. The cover of this light emitting device is made of translucent PC (polycarbonate). A diffusing member for diffusing the light emitted from the light emitting diode is disposed on an inner face of the cover. This diffusing member is formed in a uniform thickness over the inner face of the cover. The diffusing member is provided so as to cover substantially the entire inner face of the cover.

### SUMMARY

It has been discovered that because an optical directivity of a typical light emitting diode is high, the brightness of light (luminosity) of a region opposite the light emission face of the light emitting diode is greater than the brightness of light at a position that is away from the region opposite the light emission face of the light emitting diode. Furthermore, with the light emitting device in Patent Literature 1, the diffusing member is formed in a uniform thickness over the inner face of the cover, and is provided so as to cover substantially the entire inner face of the cover. It has been discovered that with this configuration, there is a problem in that the brightness of light in the region opposite the light emission face of the light emitting diode is greater than the brightness of light at the position away from the region opposite the light emission face of the light emitting diode, which results in that there will be unevenness in the brightness of the light.

One object of the present disclosure is to provide a lighting device with which less unevenness occurs in the brightness of the light.

In view of the state of the know technology, a lighting device includes a light emitting element, a board, a cover, and a diffuse reflector. The light emitting element is disposed on the board. The cover houses the light emitting element and the board. The diffuse reflector is disposed on the cover opposite a light emission face of the light emitting element. The diffuse reflector is configured to diffuse and reflect light from the light emitting element. The diffuse reflector has a thickness at a portion opposite the light emission face of the light emitting element that is greater than a thickness at a portion away from the portion opposite the light emission face of the light emitting element.

Other objects, features, aspects and advantages of the present disclosure will become apparent to those skilled in the art from the following detailed description, which, taken in conjunction with the annexed drawings, discloses selected embodiments of the lighting device.

### BRIEF DESCRIPTION OF THE DRAWINGS

Referring now to the attached drawings which form a part of this original disclosure:

FIG. 1 is a perspective view of a straight-tube LED lighting device in accordance with a first embodiment;

FIG. 2 is an exploded perspective view of the straight-tube LED lighting device illustrated in FIG. 1;

FIG. 3 is a plan view of an interior of a cover of the straight-tube LED lighting device illustrated in FIG. 1;

FIG. 4 is a cross sectional view of the straight-tube LED lighting device illustrated in FIG. 1, taken along 400-400 line in FIG. 3;

FIG. 5 is a cross sectional view of the straight-tube LED lighting device illustrated in FIG. 1, taken along 500-500 line in FIG. 3;

FIG. 6 is a cross sectional view of a modified straight-tube LED lighting device in accordance with the first embodiment;

FIG. 7 is an exploded perspective view of a straight-tube LED lighting device in accordance with a second embodiment; and

FIG. 8 is a cross sectional view of the straight-tube LED lighting device illustrated in FIG. 7.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

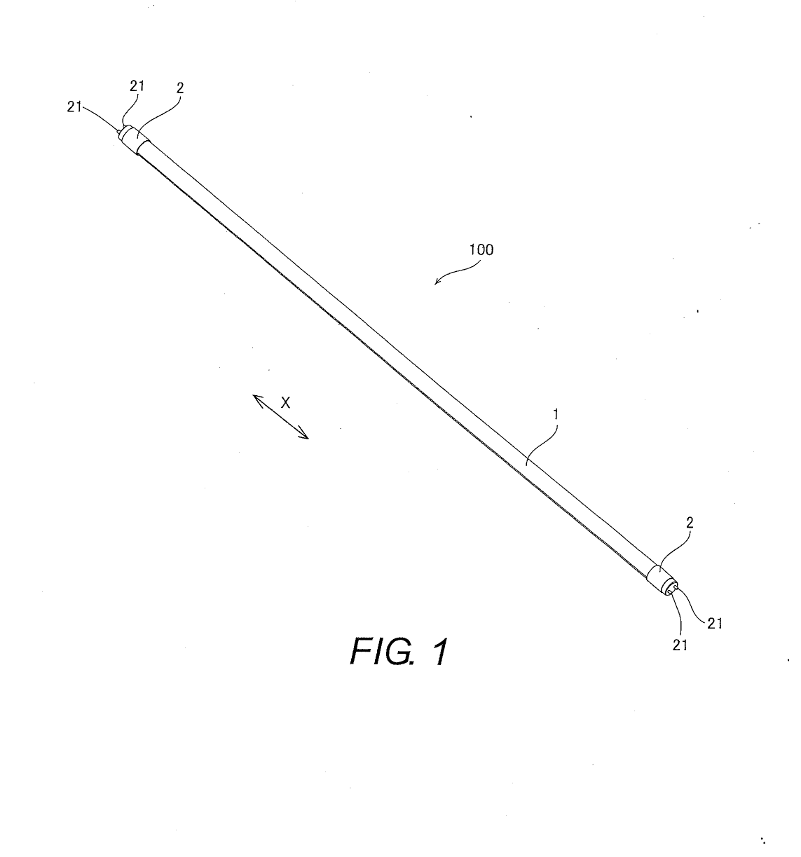

Referring initially to FIGS. 1 to 5, a straight-tube LED lighting device 100 is illustrated in accordance with a first embodiment. The straight-tube LED lighting device 100 is an example of the “lighting device” of the present invention.

As shown in FIG. 1, the straight-tube LED lighting device 100 includes a cover 1 and a pair of caps 2. The cover 1 is formed in the shape of a straight tube. The caps 2 are attached to the ends of the cover 1 in the tube axial direction (the X direction), which is the long direction of the lighting device 100. Two terminals 21 that protrude outward are provided to each of the caps 2.

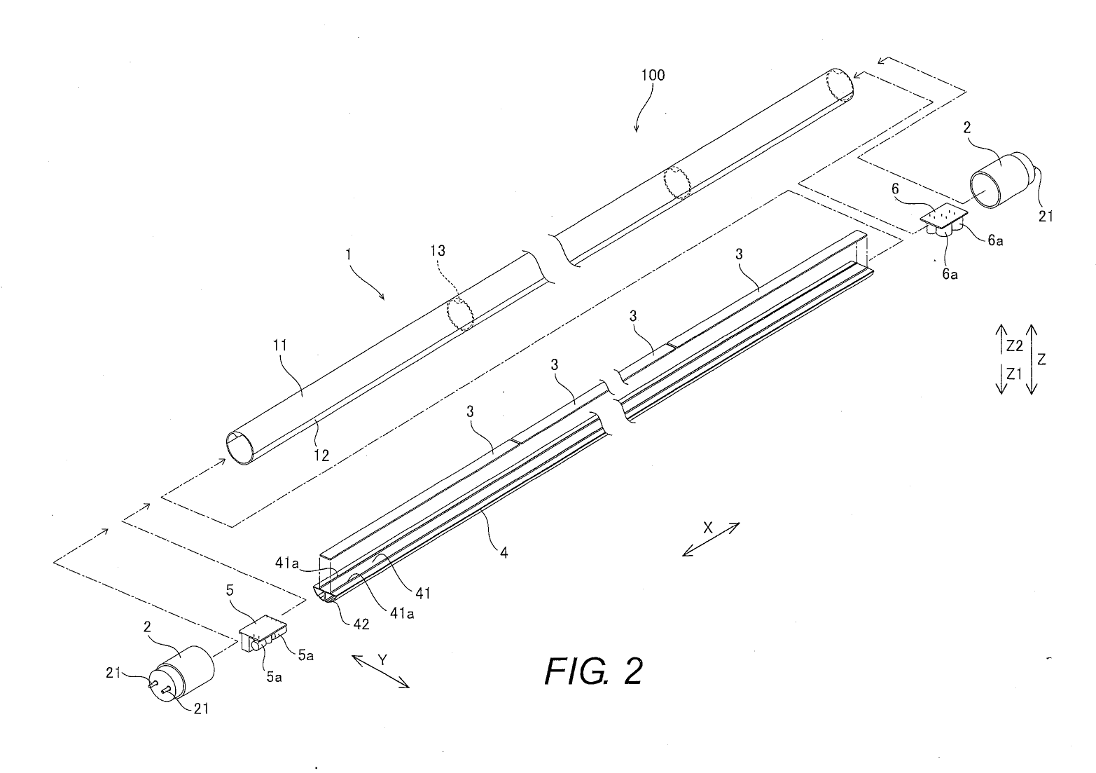

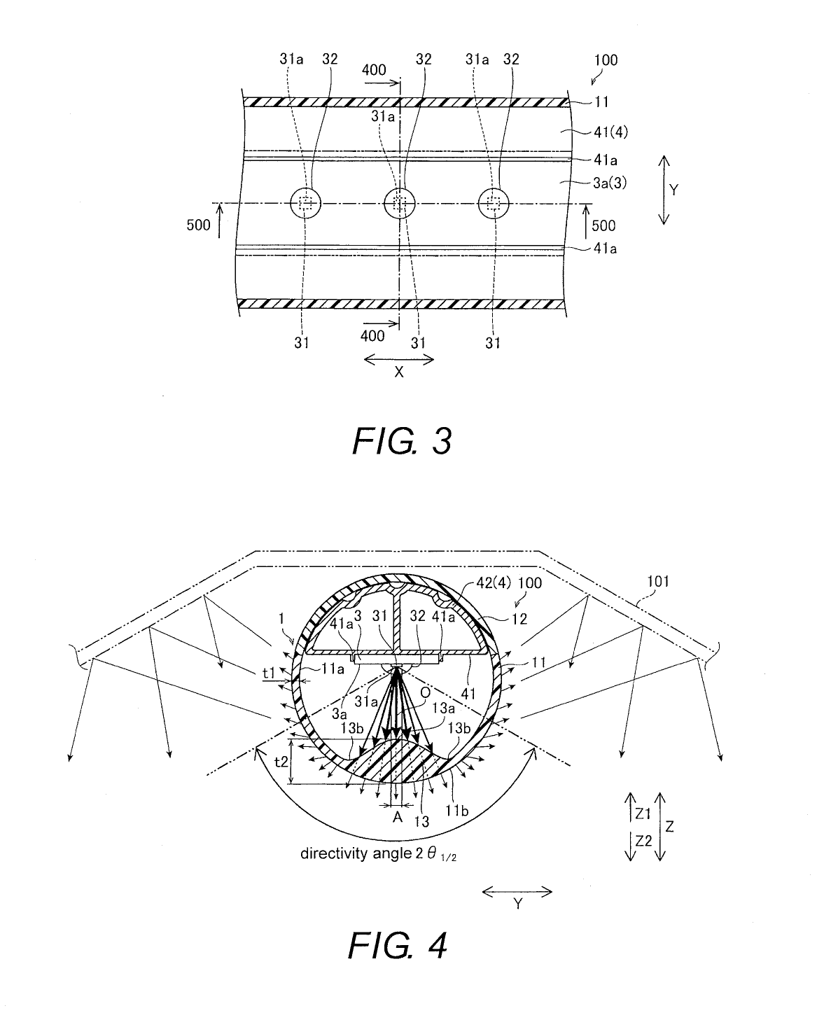

As shown in FIG. 2, a plurality of LED boards 3, a heat sink 4, a power supply board 5, a control board 6 are housed inside the cover 1. A plurality of LED elements 31 (see FIG. 3) is mounted on each of the LED board 3. The heat sink 4 dissipates heat from the LED elements 31 and supports the LED boards 3. A plurality of electronic parts 5a is mounted on the power supply board. A plurality of electronic parts 6a is mounted on the control board 6. The LED boards 3 and the LED elements 31 are examples of the “board” and the “light emitting element” of the present invention, respectively.

The cover 1 is formed in the shape of a straight tube that extends linearly in the long direction (the X direction). More specifically, as shown in FIG. 4, the cover 1 includes a front part 11 and a rear part 12. The front part 11 is disposed below (the Z2 side), while the rear part 12 is disposed above (the Z1 side) and has a substantially semicircular arc-shaped cross section. The cover 1 is formed as a straight tube in which the front part 11 and the rear part 12 are integrated. The front part 11 is disposed on a light emission face 31a side (Z2 side) of the LED elements 31. The rear part 12 is disposed on the opposite side (Z1 side) from the light emission faces 31a.

Also, the cover 1 is made of a resin material, such as a polycarbonate. With this cover 1, the front part 11 and the rear part 12 are integrally molded, respectively. The front part 11 includes a milky-white light diffusing material. The front part 11 is configured such that light emitted from the LED elements 31 is transmitted while being diffused and reflected. The rear part 12 is configured such that it does not transmit light as readily as the front part 11 does. That is, the front part 11 is semi-transparent, while the rear part 12 is substantially opaque. The cover 1 has a thickness t1 of approximately 1 mm, except for the portion where a convex component 13 (discussed below) is formed.

As shown in FIG. 2, the LED boards 3 have a rectangular shape in plan view. The LED boards 3 are formed so that they extend in the long direction (the X direction). Adjacent pairs of the LED boards 3 are connected to each other by wiring (not shown), respectively. As shown in FIG. 3, the LED elements 31 are mounted in a single row, at a specific spacing in the long direction, on mounting faces 3a of the LED boards 3.

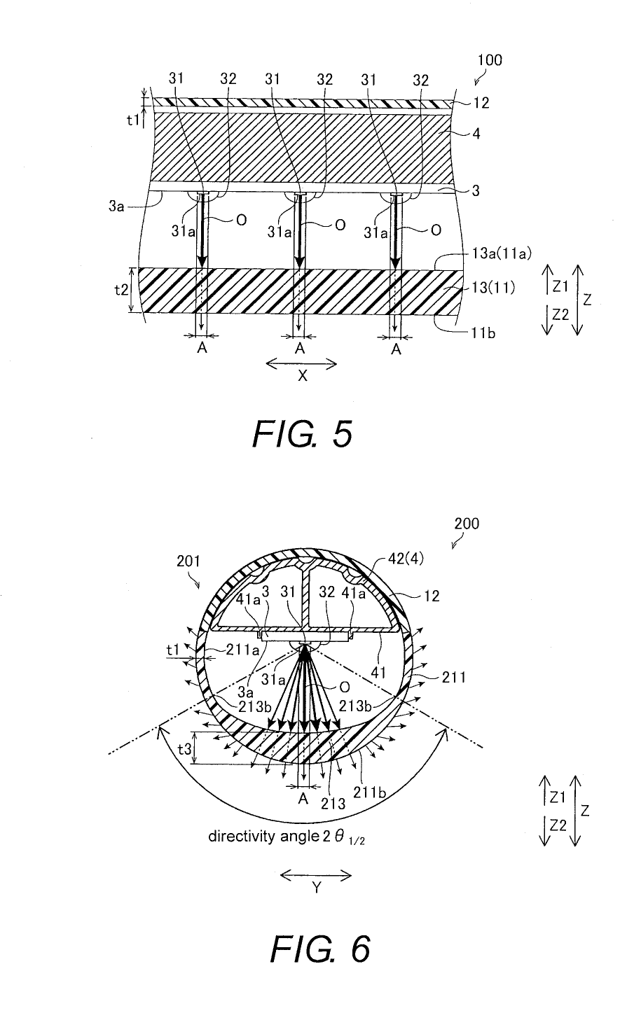

As shown in FIGS. 4 and 5, the LED elements 31 are mounted on the mounting faces 3a so that the light emission faces 31a from which the light is emitted are located on the Z2 side. Consequently, the LED elements 31 are at their brightness (highest luminance) directly under the light emission faces 31a in the Z direction (Z2 side). The Z direction is perpendicular to the X direction of the lighting device 100. As shown in FIG. 4, the LED elements 31 have a directivity angle 2θ_{1/2} (or light distribution angle) of approximately 120 degrees. In other words, at a position circumferentially away from a straight line O passing through the light emission faces 31a and extending in the Z direction by an angle of approximately 60 degrees (=θ_{1/2}), the brightness of the light from the LED elements 31 becomes half the brightness of the light directly under the light emission faces 31a in the Z direction.

In the first embodiment, the convex component 13 is formed integrally with the front part 11 on a lower part of the front part 11 (Z2 side). The convex component 13 protrudes upward or inward (to the Z1 side) from the inner face 11a of the front part 11. This convex component 13 is formed in a convex shape at a portion A that is opposite the light emission faces 31a of the LED elements 31 in the Z direction. The convex component 13 is formed such that a top 13a (e.g., apex) of the convex component 13 is located at the portion A that is opposite the light emission faces 31a of the LED elements 31. The convex component 13 has a thickness t2 at the top 13a. Furthermore, the convex component 13 is formed in mirror symmetry relative to the straight line 0 in the short direction (the Y direction). The Y direction is perpendicular to the X and Z directions. The convex component 13 is formed so that its thickness gradually decreases from the top 13a toward both ends 13b. Consequently, the thickness of the front part 11 at the convex component 13 is greater than the thickness of the front part 11 at a portion where the convex component 13 is not provided. Furthermore, the thickness of the convex component 13 at the portion A opposite the light emission faces 31a of the LED elements 31 is greater than the thickness of the front part 11 at the portion that is away in the short direction from the portion A opposite the light emission faces 31a of the LED elements 31. The thickness t2 at the top 13a is at least approximately 3 mm and no more than approximately 4 mm. The convex component 13 is an example of the “diffuse reflector” of the present invention.

The convex component 13 is formed integrally with the front part 11. The light can be transmitted while being diffused and reflected just as with the front part 11. The thick convex component 13 here includes more light diffusing material than the thin portion where the convex component 13 is not provided. Consequently, the configuration is such that the ratio of the amount of diffuse reflected light (or diffused and reflected light) to the amount of transmitted light at the convex component 13 is greater than the ratio of the amount of diffuse reflected light to the amount of transmitted light at the front part 11 in the portion where the convex component 13 is not provided. As a result, of the light emitted from the LED elements 31, more of the light that has reached the convex component 13 is diffused and reflected within the convex component 13. This reduces the amount of light transmitted through the convex component 13. The light diffused and reflected in the convex component 13 then reaches the portion where the convex component 13 is not provided. This increases the amount of light in the portion where the convex component 13 is not provided.

As a result, the light diffused and reflected in the convex component 13 reaches not only the Z2 side of the light emission faces 31a, but also the Z1 side. This light that has reached the Z1 side of the light emission faces 31a is reflected over a wide range on the Z2 side by a reflecting plate 101 (two-dot chain line) disposed on the Z1 side of the straight-tube LED lighting device 100. With this configuration, the light of the straight-tube LED lighting device 100 irradiates a wide range on the Z2 side.

Also, in the first embodiment, the ends 13b in the Y direction of the convex component 13 located at the boundaries between the convex component 13 and the portion where the convex component 13 is not provided are located within the range of the directivity angle 2θ_{1/2} of the LED elements 31. Consequently, all of the convex component 13 (i.e., the entire convex component 13) is located within a range of the directivity angle 2θ_{1/2} of the LED elements 31. More specifically, as shown in FIG. 4, the convex component 13 is circumferentially disposed between the ends 13b about an imaginary axis passing through the light emission faces 31a of the LED elements 31 and parallel to the X direction. The convex component 13 is circumferentially located within the range of the directivity angle 2θ_{1/2} of approximately 120 degrees about the imaginary axis.

The convex component 13 and the portion where the convex component 13 is not provided on the inner face 11a of the front part 11 are connected in a smooth curved line or surface at the ends 13b in the Y direction, respectively. That is, the inner face 11a of the front part 11 at the ends 13b is formed in a curved line or surface having a specific radius of curvature as viewed in the X direction.

As shown in FIG. 2, the convex component 13 is also formed so as to extend in a uniform thickness in the long direction (X direction). That is, as shown in FIG. 5, the convex component 13 at the top 13a is formed so as to extend with the uniform thickness t2 in the long direction. The height position of the convex component 13 is constant in the long direction.

A plurality of fluorescent members or materials 32 are provided to the mounting faces 3a of the LED boards 3. The fluorescent members 32 have a dome shape (hemispherical shape). The fluorescent members 32 cover the LED elements 31, respectively. The fluorescent members 32 have a resin material and a fluorescent material. The fluorescent members 32 are designed to release fluorescent light upon receiving light emitted from the light emission faces 31a of the LED elements 31.

The heat sink 4 is made of a metal material with excellent thermal conductivity, such as an aluminum material. As shown in FIG. 2, the heat sink 4 is formed so as to extend in the long direction (the X direction). The heat sink 4 includes a flat part 41, and an arc-shaped part 42. The flat part 41 is disposed on the Z2 side. The LED boards 3 are placed on the flat part 41. The arc-shaped part 42 is disposed on the Z1 side. A pair of guides 41a for guiding the LED boards 3 is provided to the flat part 41. As shown in FIG. 4, the arc-shaped part 42 is formed so as to conform to the inner face of the rear part 12 of the cover 1.

As discussed above, in the first embodiment, the thickness of the convex component 13 at the portion A opposite the light emission faces 31a of the LED elements 31 is greater than the thickness of the front part 11 at the portion away from the portion A opposite the light emission faces 31a of the LED elements 31 in the short direction (the Y direction). Consequently, more light can be diffused and reflected at the portion A opposite the light emission faces 31a of the LED elements 31, where the light is brighter, than at the portion that is away from the portion A opposite the light emission faces 31a of the LED elements 31. Thus, the brightness of the light can be reduced at the portion A opposite the light emission faces 31a of the LED elements 31. Furthermore, the brightness of light can be increased in the other portion by diffusing to the other portion the light that has been diffused and reflected at the portion A opposite the light emission faces 31a of the LED elements 31. As a result, less unevenness in the brightness of light in the short direction occurs in the overall region of the straight-tube LED lighting device 100 in the long direction (the X direction).

Also, in the first embodiment, the convex component 13 is formed integrally with the front part 11 of the cover 1 so as to be opposite the LED elements 31. Thus, the fluorescent members 32 do not need to be formed in any special shape to diffuse and reflect the light in a specific direction. Therefore, there is no need for difficult machining of the shape of the fluorescent members 32. This allows the straight-tube LED lighting device 100 to be produced more easily.

Also, in the first embodiment, the entire convex component 13 is located within the range of the directivity angle 2θ_{1/2} of the LED elements 31. Thus, the convex component 13 can diffuse and reflects the light within the directivity angle 2θ_{1/2} having large brightness. Therefore, unevenness of the brightness of the light can be reduced more effectively.

Also, in the first embodiment, the ratio of the amount of diffuse reflected light to the amount of transmitted light in the convex component 13 is greater than the ratio of the amount of diffuse reflected light to the amount of transmitted light in the front part 11 at the portion where the convex component 13 is not provided. Consequently, the amount of diffuse reflected light in the convex component 13 can be increased over the amount of diffuse reflected light in the front part 11 at the portion wherein the convex component 13 is not provided. Therefore, unevenness in the brightness of light can be further reduced.

Also, in the first embodiment, the thickness of the front part 11 in the convex component 13 is greater than the thickness of the front part 11 at the portion where the convex component 13 is not provided. Thus, unlike when the convex component 13 is provided separately from the front part 11 of the cover 1, it is easy to make the boundary between the convex component 13 and the portion where the convex component 13 is not provided less visible to the user. Furthermore, the configuration of the straight-tube LED lighting device 100 can be simplified.

Also, in the first embodiment, the convex component 13 is formed so that the top 13a, which has the greatest thickness t2, is located in the portion A opposite the light emission faces 31a of the LED elements 31. Thus, the most light can be easily diffused and reflected in the portion A opposite the light emission faces 31a of the LED elements 31, where the light is brightest. Therefore, unevenness in the brightness of light can be effectively reduced. Also, the thickness of the portion A opposite the light emission faces 31a of the LED elements 31 in the cover 1 can be increased more easily than when the convex component 13 has a concave shape.

Also, in the first embodiment, the convex component 13 is formed so that its thickness gradually decreases from the top 13a toward the ends 13b. Thus, the portion where the thickness of the front part 11 changes is less visible to the user than when the thickness of the front part 11 of the cover 1 decreases suddenly.

Also, in the first embodiment, the convex component 13 and the portions where the convex component 13 is not provided are connected at the inner face 11a of the front part 11 in a smooth curved line or surface at both ends 13b in the Y direction. Consequently, the boundaries (the ends 13b) between the convex component 13 and the portions where the convex component 13 is not provided are less visible to the user.

Also, in the first embodiment, the convex component 13 is formed so as to extend in a uniform thickness in the long direction (the X direction). Thus, there is no need to change the shape of the convex component 13 in the long direction to match the position of the LED elements 31. Therefore, the convex component 13 extending in the long direction can be formed more easily.

Also, in the first embodiment, the convex component 13 is provided to the front part 11 of the cover 1. Thus, the convex component 13 can be positioned more easily than when the convex component 13 is disposed at a distance from the cover 1. This allows the straight-tube LED lighting device 100 to be produced more easily.

Referring to FIG. 6, a straight-tube LED lighting device 200 is illustrated in accordance with a modification example of the first embodiment. In this modification example of the first embodiment, a thick part 213 is formed on a front part 211 of a cover 201. The thick part 213 does not protrude from an inner face 211a of the front part 211.

As shown in FIG. 6, with the straight-tube LED lighting device 200, the thick part 213 is formed integrally with the front part 211 on the lower part (the Z2 side) of the front part 211 of the cover 201. This thick part 213 is provided at the portion A opposite the light emission faces 31a of the LED elements 31. The thick part 213 is formed so that the thick part 213 has the largest thickness t3 (thickest) at the portion A opposite the light emission faces 31a of the LED elements 31. Also, the configuration is such that the degree of curvature (curvature or reciprocal of radius of curvature) of the arc of the inner face 211a at the thick part 213 is less than the degree of curvature of the arc of an outer face 211b of the front part 211. Consequently, the thick part 213 is formed so as to have a crescent-shaped cross section that gradually becomes thinner from the portion A opposite the light emission faces 31a of the LED elements 31 toward the ends 213b in the Y direction. The straight-tube LED lighting device 200 is an example of the “lighting device” of the present invention. The thick part 213 is an example of the “diffuse reflector” of the present invention.

Also, the ends 213b in the Y direction of the thick part 213 located at the boundaries between the thick part 213 and the portion where the thick part 213 is not provided are provided at positions that overlap the directivity angle 2θ_{1/2} of the LED elements 31. Consequently, the entire thick part 213 is provided so as to be located within the range of the directivity angle 2θ_{1/2} of the LED elements 31. Other effects and parts of the configuration in this modification example of the first embodiment are substantially the same as those in the first embodiment.

### Second Embodiment

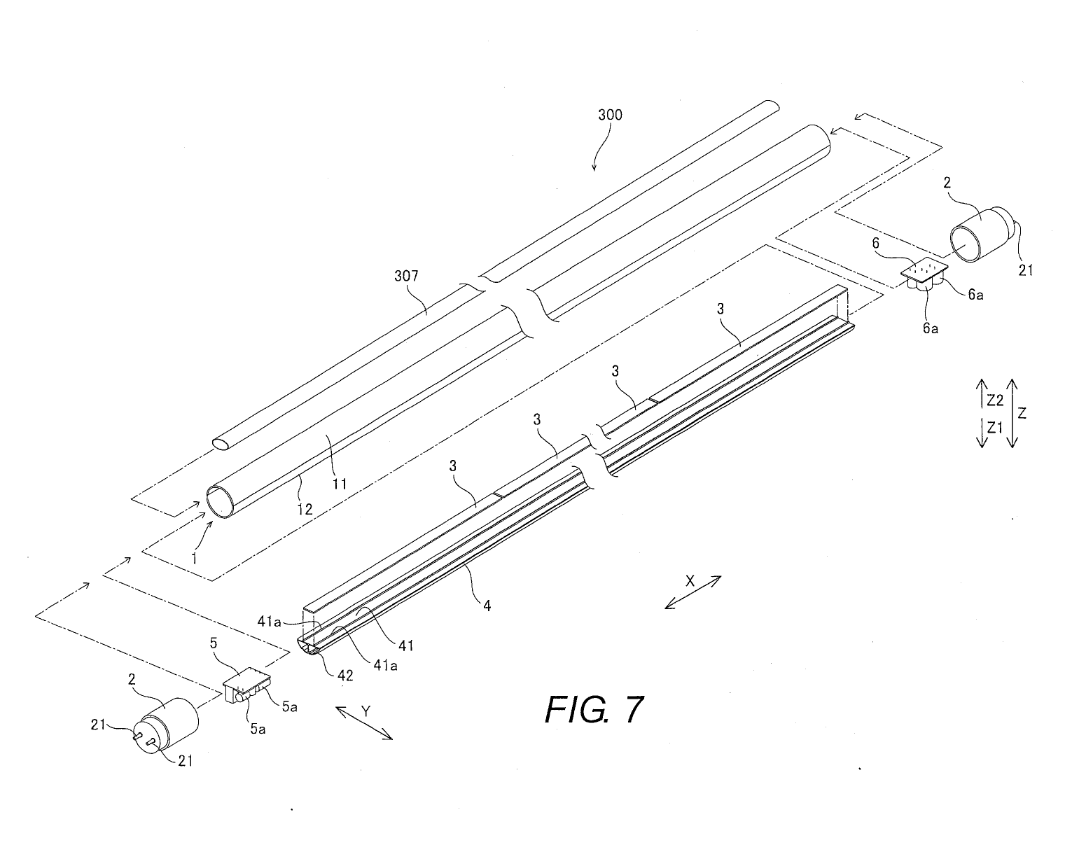

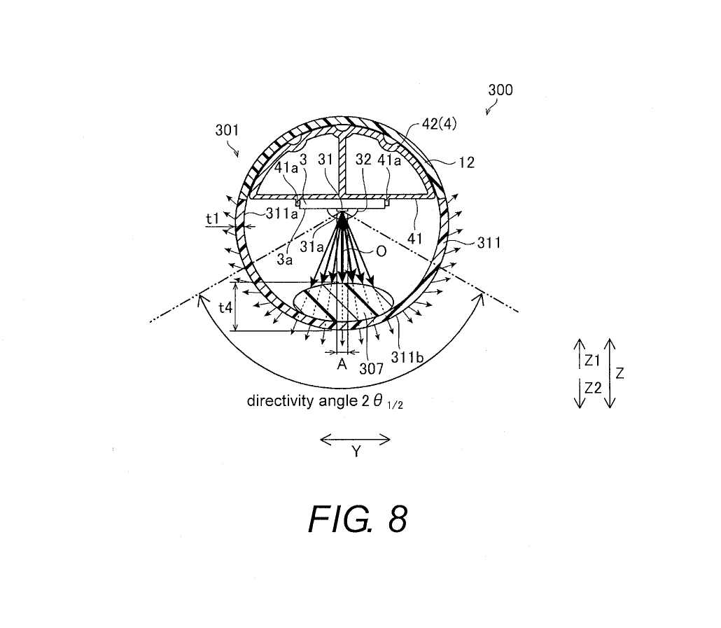

Referring now to FIGS. 7 and 8, a straight-tube LED lighting device 300 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. In this second embodiment, unlike in the first embodiment, a diffuse reflection member 307 is disposed on an inner face 311a of a front part 311 of a cover 301. The diffuse reflection member 307 is provided separately from the front part 311 of the cover 301.

As shown in FIGS. 7 and 8, with the straight-tube LED lighting device 300, the cover 301 is formed in a uniform thickness t1 (see FIG. 8). The diffuse reflection member 307 is disposed on the inside of the cover 301. The diffuse reflection member 307 is provided separately from the front part 311, as a separate member. As shown in FIG. 7, this diffuse reflection member 307 is a round piece extending in a uniform thickness in the long direction (the X direction). The diffuse reflection member 307 is mounted to the inner face 311a of the front part 311 with a translucent adhesive agent (not shown), and thereby fixed on the inside of the cover 301. The straight-tube LED lighting device 300 is an example of the “lighting device” of the present invention. The diffuse reflection member 307 is an example of the “diffuse reflector” of the present invention.

As shown in FIG. 8, the diffuse reflection member 307 is formed in an elliptical shape such that its cross sectional shape is longer in the short direction (the Y direction) than in the Z direction. The diffuse reflection member 307 contacts with the inner face 311a of the front part 311 at the portion A opposite the light emission faces 31a of the LED elements 31. Consequently, in the second embodiment, the combined thickness of the front part 311 and the diffuse reflection member 307 at the portion A opposite the light emission faces 31a of the LED elements 31 is greater than the thickness at the portion that is away in the short direction from the portion A opposite the light emission faces 31a of the LED elements 31. Furthermore, the combined thickness t4 of the front part 311 and the diffuse reflection member 307 at the portion where the diffuse reflection member 307 is disposed is greater than the thickness t1 of the cover 301 at the portion where the diffuse reflection member 307 is not disposed.

The diffuse reflection member 307 is made of the same resin material and the same light diffusing material as the front part 311 of the cover 301. Consequently, the diffuse reflection member 307 is configured so that light emitted from the LED elements 31 is transmitted while being diffused and reflected. Also, the diffuse reflection member 307 is disposed so as to be located within the range of the directivity angle 2θ_{1/2} of the LED elements 31 in the short direction of the front part 311 (the Y direction). The rest of the configuration of the second embodiment is substantially the same as that in the first embodiment above.

With the second embodiment, as discussed above, the combined thickness of the front part 311 and the diffuse reflection member 307 at the portion A opposite the light emission faces 31a of the LED elements 31 is greater than the thickness at the portion that is away in the short direction (the Y direction) from the portion A opposite the light emission faces 31a of the LED elements 31. Consequently, the brightness of the light can be reduced in the portion A opposite the light emission faces 31a of the LED elements 31, while the brightness can be increased in the other portion. As a result, unevenness in the brightness of light in the short direction can be reduced.

Also, with the second embodiment, the diffuse reflection member 307 is provided separately from the front part 311. The diffuse reflection member 307 is disposed on the inside of the cover 301. Thus, unlike when the diffuse reflection member 307 is provided integrally with the front part 311 of the cover 301, the thickness of the portion A opposite the light emission faces 31a of the LED elements 31 can be made greater than the thickness of the portion that is away from the portion A opposite the light emission faces 31a of the LED elements 31, without changing the thickness t1 of the front part 311. Therefore, the front part 311 can be produced more easily. The other effects of the second embodiment are substantially the same as those in the first embodiment above.

The embodiments disclosed herein are just an example in every respect, and should not be interpreted as being limiting in nature. The scope of the invention being indicated by the appended claims rather than by the above description of the embodiments, all modifications within the meaning and range of equivalency of the claims are included.

For example, in the first and second embodiments above, an example was given of applying the constitution of the present invention to the straight-tube LED lighting devices 100, 200, and 300. However, the present invention is not limited to this. The constitution of the present invention can be applied to a lighting device other than a straight-tube LED lighting device, such as a light bulb type of LED lighting device.

Also, in the first and second embodiments above, the convex component 13, the thick part 213, and the diffuse reflection member 307 (e.g., diffuse reflector) extend in a uniform thickness in the long direction. However, the present invention is not limited to this. The thickness of the diffuse reflector can be varied in the long direction. For instance, the thickness of the diffuse reflector at the portion opposite the LED elements in the long direction can be greater than the thickness of the diffuse reflector at locations away from the LED elements in the long direction. Consequently, the brightness of light at the portion opposite the LED elements can be reduced, while the brightness of light at the other portion in the long direction can be increased. Thus, unevenness in the brightness of light in the long direction can be reduced.

Also, in the first and second embodiments above, the convex component 13, the thick part 213, and the diffuse reflection member 307 (e.g., diffuse reflector) are provided within the range of a directivity angle 2θ_{1/2} of approximately 120 degrees. However, the present invention is not limited to this. For example, depending on the brightness of the light of the LED lighting device, the diffuse reflector can be provided outside the range of the directivity angle 2θ_{1/2}. Also, the directivity angle 20_{1/2} can be greater than or less than approximately 120 degrees.

Also, in the first and second embodiments above, the convex component 13, the thick part 213, and the diffuse reflection member 307 (e.g., diffuse reflector) are each provided independently. However, the present invention is not limited to this. For example, the diffuse reflector can be configured by combining the thick part 213 in the modification example of the first embodiment with the diffuse reflection member 307 of the second embodiment.

Also, in the first embodiment above, the entire front part 11 of the cover 1 or the entire front part 211 of the cover 201 includes the same light diffusing material. However, the present invention is not limited to this. For example, the configuration can be such that of the front part of the cover, the front part in the portion where the diffuse reflector is provided includes the light diffusing material, while the front part in the portion where the diffuse reflector is not provided does not include the light diffusing material. Also, the properties of the light diffusing material in the diffuse reflector can be different from the properties of the light diffusing material in the portion where the diffuse reflector is not provided. For instance, of the front part of the cover, the light diffusing material of the front part in the portion where the diffuse reflector is provide can be a material that allows more light to be diffused and reflected than the light diffusing material of the front part in the portion where the diffuse reflector is not provided. This makes it possible to reduce the thickness in the diffuse reflector more than when the same light diffusing material is used. Also, the content by percentage of the light diffusing material in the diffuse reflector can be greater than the content by percentage of the light diffusing material in the portion where the diffuse reflector is not provided.

Also, in the second embodiment above, the diffuse reflection member 307 is made of the same resin material and the same light diffusing material as in the front part 311 of the cover 301. However, the present invention is not limited to this. For example, the diffuse reflection member 307 can be made of a different resin material and a different light diffusing material from those of the cover 301.

Also, in the second embodiment above, the diffuse reflection member 307 is provided separately from the front part 311. The diffuse reflection member 307 is formed by a round piece in which the cross sectional shape in the short direction is elliptical. However, the present invention is not limited to this. For example, the diffuse reflection member 307 can be a round piece having a true circular cross sectional shape.

Also, in the second embodiment above, the diffuse reflection member 307 fixedly coupled to the inner face of the cover 301 by bonding the diffuser reflection member 307 to the inner face 311a of the front part 311 with a translucent adhesive agent. However, the present invention is not limited to this. For example, a latching component can be provided extending in the long direction on the inner face of the cover. The diffuse reflection member can be latched to this latching component, thereby fixing the diffuse reflection member on the inside of the cover. Furthermore, the ends of the diffuse reflection member in the long direction can be fixed to the two caps, respectively, thereby fixing the diffuse reflection member on the inside of the cover. The direction in which the LED elements emit light (the Z2 side; see FIG. 8) is the vertically downward direction. Thus, the configuration can be such that the diffuse reflection member is not fixed inside the cover. The diffuse reflection member can be instead located at a portion opposite the LED elements by the weight of the diffuse reflection member itself.

The lighting device pertaining to one aspect includes a light emitting element, a board, a cover, and a diffuse reflector. The light emitting element is disposed on the board. The cover houses the light emitting element and the board. The diffuse reflector is disposed on the cover opposite a light emission face of the light emitting element. The diffuse reflector is configured to diffuse and reflect light from the light emitting element. The diffuse reflector has a thickness at a portion opposite the light emission face of the light emitting element that is greater than a thickness at a portion away from the portion opposite the light emission face of the light emitting element.

With the lighting device pertaining to this aspect, as discussed above, the diffuse reflector diffuses and reflects the light from the light emitting element. The diffuse reflector has the thickness at the portion of the diffuse reflector that is opposite the light emission face of the light emitting element. This thickness is greater than the thickness at the portion of the diffuse reflector that is away from the portion opposite the light emission face of the light emitting element. Consequently, more light can be diffused and reflected at the portion opposite the light emission face of the light emitting element, where the light is brighter, than at the portion away from the portion opposite the light emission face of the light emitting element. Thus, the brightness of the light can be reduced at the portion opposite the light emission face of the light emitting element. The light that has been diffused and reflected at the portion opposite the light emission face of the light emitting element can be diffused and reflected towards the other portion. This increases the brightness of the light in the other portion. As a result, less unevenness occurs in the brightness of the light.

With the lighting device pertaining to this aspect, the diffuse reflector can be arranged relative to the cover such that the diffuse reflector is located within a range of a directivity angle of the light emitting element. With this configuration, light within the range of the directivity angle with high brightness can be diffused and reflected. Thus, unevenness in the brightness of light can be reliably reduced.

With the lighting device pertaining to this aspect, the cover is configured to diffuse and reflect the light from the light emitting element. The cover and the diffuse reflector are configured such that a ratio of an amount of diffuse reflected light to an amount of transmitted light at the diffuse reflector is greater than a ratio of an amount of diffuse reflected light to an amount of transmitted light at a portion of the cover where the diffuse reflector is not provided. With this configuration, the amount of diffuse reflected light at the diffuse reflector can be increased over the amount of diffuse reflected light at the portion of the cover where the diffuse reflector is not provided. Thus, unevenness in the brightness of light can be further reduced.

In this case, the diffuse reflector is formed integrally with the cover. The cover has a thickness at the diffuse reflector that is greater than a thickness at the portion of the cover where the diffuse reflector is not provided. The portion of the cover where the diffuse reflector is not provided means a portion of the cover other than or except for a portion where the diffuse reflector is provided. With this configuration, unlike when the diffuse reflector is provided separately from the cover, the boundary between the diffuse reflector and the portion where the diffuse reflector is not provided will not be readily visible to the user. Furthermore, the configuration of the lighting device can be simplified.

With the configuration in which the diffuse reflector is formed integrally with the cover, the cover and the diffuse reflector can be configured such that the thickness at the diffuse reflector is greatest at the portion opposite the light emission face of the light emitting element. With this configuration, the most light can be diffused and reflected at the portion opposite the light emission face of the light emitting element, where the light is brightest. Thus, unevenness in the brightness of light can be effectively reduced.

With the configuration in which the thickness of the cover is greatest at the opposite portion, the cover and the diffuse reflector can be configured such that the thickness at the diffuse reflector decreases gradually as moving away from the portion opposite the light emission face of the light emitting element. With this configuration, the portion where the thickness of the cover changes will be less visible to the user than when the thickness of the cover decreases abruptly.

With the configuration in which the thickness of the cover is greatest at the opposite portion, the diffuse reflector can have a convex shape with a top or apex that is located at the portion opposite the light emission face of the light emitting element. With this configuration, the greatest amount of light can be easily diffused and reflected at the portion opposite the light emission face of the light emitting element, where the light is brightest.

In this case, the convex diffuse reflector can protrude from an inner face of the cover. The inner face of the cover at the diffuse reflector is smoothly connected in a curved surface fashion with the inner face of the cover at the portion where the diffuse reflector is not provided. With this configuration, the boundary between the diffuse reflector and the portion where the diffuse reflector is not provided will be even less visible to the user.

With the lighting device pertaining to this aspect, the diffuse reflector includes a diffuse reflection member. The diffuse reflection member is independently formed as a separate member from the cover. The cover and the diffuse reflection member have a total or combined thickness at a portion where the diffuse reflection member is disposed that is greater than a thickness at a portion of the cover where the diffuse reflection member is not disposed. With this configuration, unlike when the diffuse reflector is provided integrally to the cover, the thickness of the cover is not changed. The thickness of the portion opposite the light emission face of the light emitting element can be made greater than the thickness of the portion away from the portion opposite the light emission face of the light emitting element. This makes it easier to produce the cover.

With the lighting device pertaining to this aspect, the board extends in a long direction of the lighting device. The cover has a tubular shape, and extends in the long direction. A plurality of the light emitting elements is disposed in the long direction along the board. The diffuse reflector has the thickness at the portion opposite the light emission face of the light emitting element that is greater than the thickness at the portion away from the portion opposite the light emission face of the light emitting element in a short direction that is perpendicular to the long direction. The diffuse reflector extends in the long direction along the cover with a substantially uniform thickness. With this configuration, unevenness in the brightness of light in the short direction can be reduced in the entire region in the long direction of a straight-tube lighting device.

With the present invention, as discussed above, unevenness in the brightness of light can be reduced.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A lighting device comprising:
a light emitting element;
a board on which the light emitting element is disposed;
a cover housing the light emitting element and the board; and
a diffuse reflector disposed on the cover opposite a light emission face of the light emitting element, the diffuse reflector being configured to diffuse and reflect light from the light emitting element, the diffuse reflector having a thickness at a portion opposite the light emission face of the light emitting element that is greater than a thickness at a portion away from the portion opposite the light emission face of the light emitting element.

2. The lighting device according to claim 1, wherein
the diffuse reflector is arranged relative to the cover such that the diffuse reflector is located within a range of a directivity angle of the light emitting element.

3. The lighting device according to claim 1, wherein
the cover is configured to diffuse and reflect the light from the light emitting element, and
the cover and the diffuse reflector are configured such that a ratio of an amount of diffuse reflected light to an amount of transmitted light at the diffuse reflector is greater than a ratio of an amount of diffuse reflected light to an amount of transmitted light at a portion of the cover where the diffuse reflector is not provided.

4. The lighting device according to claim 3, wherein
the diffuse reflector is formed integrally with the cover, and
the cover has a thickness at the diffuse reflector that is greater than a thickness at the portion of the cover where the diffuse reflector is not provided.

5. The lighting device according to claim 4, wherein
the cover and the diffuse reflector are configured such that the thickness at the diffuse reflector is greatest at the portion opposite the light emission face of the light emitting element.

6. The lighting device according to claim 5, wherein
the cover and the diffuse reflector are configured such that the thickness at the diffuse reflector decreases gradually as moving away from the portion opposite the light emission face of the light emitting element.

7. The lighting device according to claim 5, wherein
the diffuse reflector has a convex shape with an apex that is located at the portion opposite the light emission face of the light emitting element.

8. The lighting device according to claim 7, wherein
the diffuse reflector protrudes from an inner face of the cover, and
the inner face of the cover at the diffuse reflector is smoothly connected with the inner face of the cover at the portion of the cover where the diffuse reflector is not provided.

9. The lighting device according to claim 1, wherein
the diffuse reflector includes a diffuse reflection member, the diffuse reflection member being independently formed as a separate member from the cover, and
the cover and the diffuse reflection member have a total thickness at a portion where the diffuse reflection member is disposed that is greater than a thickness at a portion of the cover where the diffuse reflection member is not disposed.

10. The lighting device according to claim 1, wherein
the board extends in a long direction of the lighting device,
the cover has a tubular shape, and extends in the long direction,
a plurality of light emitting element is disposed in the long direction along the board, and
the diffuse reflector has the thickness at the portion opposite the light emission face of the light emitting element that is greater than the thickness at the portion away from the portion opposite the light emission face of the light emitting element in a short direction that is perpendicular to the long direction, the diffuse reflector extending in the long direction along the cover with a substantially uniform thickness.
